(19) United States
(12) Patent Application Publication
(10) Pub. No.: US 2011/0169272 A1
(43) Pub. Date: Jul. 14, 2011

(54) Auto-Charging Battery System

(76) Inventor: Omid Esfandiary, Torbate Heydariye (IR)

(21) Appl. No.: 12/686,974

(22) Filed: Jan. 13, 2010

(51) Int. Cl. F03G 7/08

(52) U.S. Cl. 290/1 A

(57) ABSTRACT

A system for automatically recharging a battery includes a converter that responds to indirect, reactive forces (e.g. vibrations and jerks) that are externally applied to the system. The response is a generation of electrical energy. A central controller in the system can then, simultaneously or selectively: 1) route this electrical energy directly to a user; 2) transfer the electrical energy to a battery for the recharging of the battery; and 3) divert the electrical energy to a storage unit for subsequent use in recharging the battery or direct use by the user.

### FIELD OF THE INVENTION

The present invention pertains generally to battery rechargers. More particularly, the present invention pertains to systems for continuously and automatically recharging batteries. The present invention is particularly, but not exclusively, useful as a system for recharging a battery wherein the system includes a generating unit for continuously converting kinetic energy into electrical energy, and a storage unit for storing the electrical energy for either immediate or subsequent use in recharging of the battery.

### BACKGROUND OF THE INVENTION

By definition, energy is the capacity of a body for doing work. Further, work is accomplished by moving a force through a distance and, also by definition, work is a manifestation of energy. Moreover, in accordance with Newtonian physics, it is well known that a body (i.e. a mass) creates a force when it is accelerated. With all of the above in mind, and considering the physical inter-relationships of these concepts, it can be appreciated that a moving body will generate energy. Indeed, many examples of this phenomenon can be cited. Within the present context, energy can be either mechanical or electrical. And, as is well known, the two different forms of energy can be converted from one to the other.

For a conversion of mechanical energy into electrical energy, it is well known that kinetic energy created by the movement of a magnetic field (e.g. movement of a permanent magnet) relative to a conductor coil will create an electrical current in the conductor coil. This current can then be stored as electrical energy in a capacitor. Although there are many different kinds and types of systems, machines and apparatuses for generating and storing electrical energy, the traditional approach has been to somehow harness the direct effects of the forces. For instance, solar, wind, hydro and petrochemical sources are all commonly considered for generating storable electrical energy. There are, however, other effective force systems for generating energy. In particular, many unharnessed and overlooked force generators can be effective sources of energy. In general, these are indirect reactive forces that result from random object movements such as those caused by vibrations, collisions, shaking, jerks, and shocks. Though such forces may be inconsistent, irregular and/or of variable modulation they, nevertheless, are capable of generating storable energy.

In light of the above, it is an object of the present invention to provide a system and a method for its use that effectively harnesses indirect, reactive forces for generating storable electric energy. Another object of the present invention is to provide a system and method for recharging a battery, while simultaneously using energy from the battery for work. Still another object of the present invention is to provide a system and method for recharging a battery that is easy to use, is simple to manufacture and is comparatively cost effective.

### SUMMARY OF THE INVENTION

In accordance with the present invention, a system for automatically recharging a battery includes an energy converter for generating electrical energy from kinetic energy. The electrical energy that is generated can then be used to recharge a battery, or it can be stored in a storage unit for subsequent use in recharging the battery. As controlled by a central controller (i.e. a central control system), the electrical energy is either transferred directly to the battery, or it is diverted to the storage unit (e.g. a capacitor). For this function, control depends primarily on the charge state of the battery, and on how much storage capacity remains in the storage unit.

In combination, components for the system of the present invention include a rechargeable battery, an energy converter, and a central controller. More specifically, the rechargeable battery can be of any type well known in the pertinent art. Further, the energy converter will be of a size and arrangement that is compatible with the battery. As envisioned for the present invention, the central controller determines where the electrical energy that is generated by the converter will be transferred or diverted in the system.

Structurally, the energy converter will include at least one permanent magnet that is surrounded by a dedicated coiled conductor. In this arrangement, the permanent magnet is free to reciprocally move along a substantially linear pathway inside the coiled conductor. In particular, this movement will be in response to any force that is externally applied to the system. In accordance with well known physical principles, such a movement of the permanent magnet will then generate an electrical current in the coiled conductor. This current will have an alternating current (a.c.) that can be characterized as electrical energy.

Whenever an a.c. current is generated by the mechanical components of the converter, it is rectified and will be used in the system as determined by a central controller. Specifically, as determined by the central controller, the electrical energy from the converter can be sent either directly to the battery for recharging the batter, or to a storage unit where it can be stored for subsequent use. Thus, the essential function of the central controller is to determine where the electrical energy is to be directed in the system.

As indicated above, the system of the present invention includes a storage unit. Preferably, the storage unit is a capacitor and the central controller monitors the storage capability of the storage unit. Specifically, this storage capability is expressed as a percentage of the full capacity of the storage unit. In any event, based on the charge state of the battery and the availability of storage capability in the storage unit, the central controller can cause the system to operate in either of several modes. These are: Mode I—transfer electrical energy directly from the converter to the battery for use; Mode II—divert electrical energy to the storage unit for storage and subsequent use; Mode III—provide electrical energy from the converter for direct use; Mode IV—stop recharging the battery and divert all electrical energy from the converter into the storage unit until the battery is recharged; and Mode V—continuous use of the battery with any of the Modes I-IV.

In a preferred operation, Mode I will be used so long as the storage unit is filled to greater than approximately 90% of its full capacity. Modes I, II and III will be used whenever the storage unit is filled to between about 10% to 90% of its full capacity. And, Mode IV will be used whenever the storage unit falls below about 10% of its full capacity. Mode V pertains at all times.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a plan view of a system for automatically recharging a battery in accordance with the present invention;

FIG. 2A is a schematic view of a preferred embodiment of the kinetic energy-electrical energy converter of the present invention;

FIG. 2B is a schematic view of an alternate embodiment of the kinetic energy-electrical energy converter of the present invention;

FIG. 3 is an illustration of components and the associated energy characteristics relative thereto for the system shown in FIG. 1; and

FIG. 4 is an operational flow chart for the functioning of a central controller of the system of the present invention.

### DESCRIPTION OF THE PREFERRED EMBODIMENTS

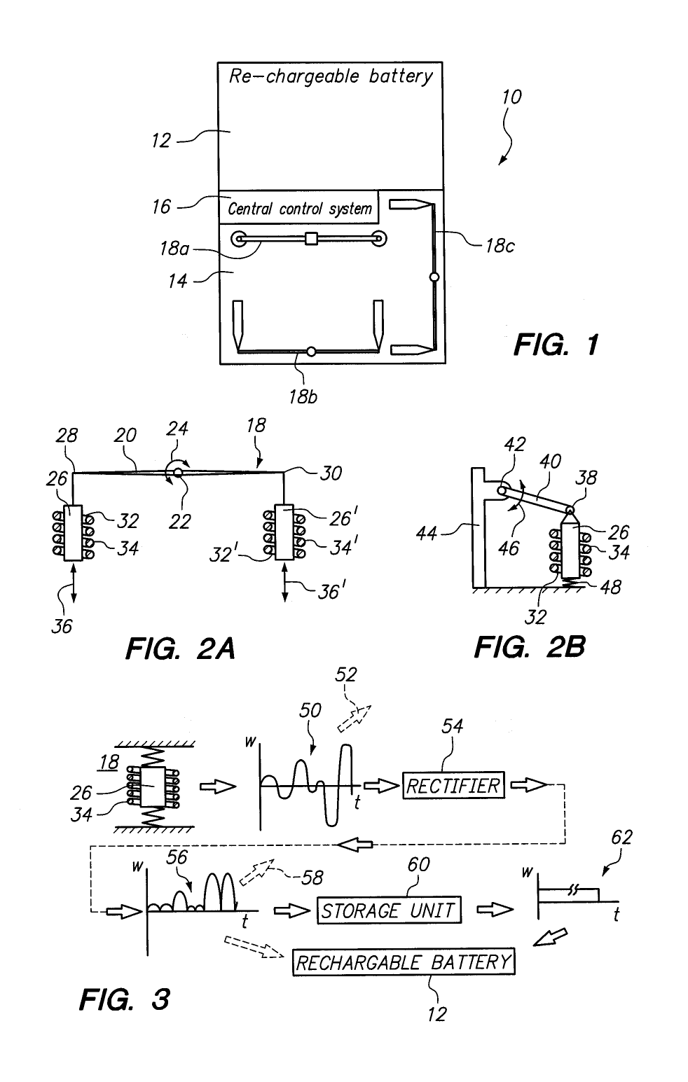

Referring initially to FIG. 1 a system for automatically recharging a battery in accordance with the present invention is shown and is generally designated 10. As shown, the system 10 includes a re-chargeable battery 12 that is electrically connected to a converter 14. As intended for the present invention, a central controller 16 is also used to coordinate the operation of the system 10.

In greater detail, FIG. 1 shows that a preferred embodiment of the converter 14 includes three kinetic-electrical energy conversion units 18a, 18b, and 18c. Specifically, these units 18a,b,c are respectively positioned so at least one of the units 18a,b,c will respond to any external force that may be applied to the system 10. To do this, the individual energy conversion units 18a,b,c are oriented for rotation about three, substantially orthogonal axes (e.g. x-y-z). In order to understand their operation, an exemplary energy conversion unit 18 is shown in FIG. 2A.

The energy conversion unit 18 shown in FIG. 2A includes a lever arm 20 that is supported for rotation around a fulcrum 22 in directions indicated by the arrow 24. FIG. 2A also shows that a permanent magnet 26 is suspended from an end 28 of the lever arm 20, and that another permanent magnet 26′ is suspended from the opposite end 30 of the lever arm 20. It is also shown in FIG. 2A that the magnets 26 and 26′ are positioned to move linearly along respective pathways 32 and 32′. In particular, the pathways 32 and 32′ are created by the respective conductor coils 34 and 34′. With this arrangement, any rotation of the lever arm 20 around the fulcrum 22 will cause the magnets 26 and 26′ to move relative to the conductor coils 34 and 34′ in directions indicated by arrows 36 and 36′. These movements of the magnets 26 and 26′ will then generate an electrical current in the coils 34 and 34′. For purposes of the present invention, the magnets 26 and 26′ are preferably permanent magnets of any type well known in the pertinent art, such as magnets made of Neodium, or SMC, or any other material having strong magnetic properties. Further, the magnets 26 and 26′ can be electrical magnets.

An alternate embodiment for an energy conversion unit 18 is shown in FIG. 2B. For this alternate embodiment, a permanent magnet 26 is suspended from an end 38 of an extension arm 40. The end of extension arm 40 that is opposite end 38 is mounted at a pivot point 42 on a base 44. As so mounted, the extension arm 40 is set to rotate around the pivot point 42 in directions indicated by the arrow 46. With this movement of the extension arm 40, the permanent magnet 26 is moved in the pathway 32 of the conductor coil 34, to generate a current in the conductor coil 34. A spring 48 is shown connected to the magnet 26 in FIG. 2B for the purpose of stabilizing the magnet 26 as it is moved within the pathway 32. For the present invention, the spring 48 is preferably made of steel, or of some other non-magnetic pliable material.

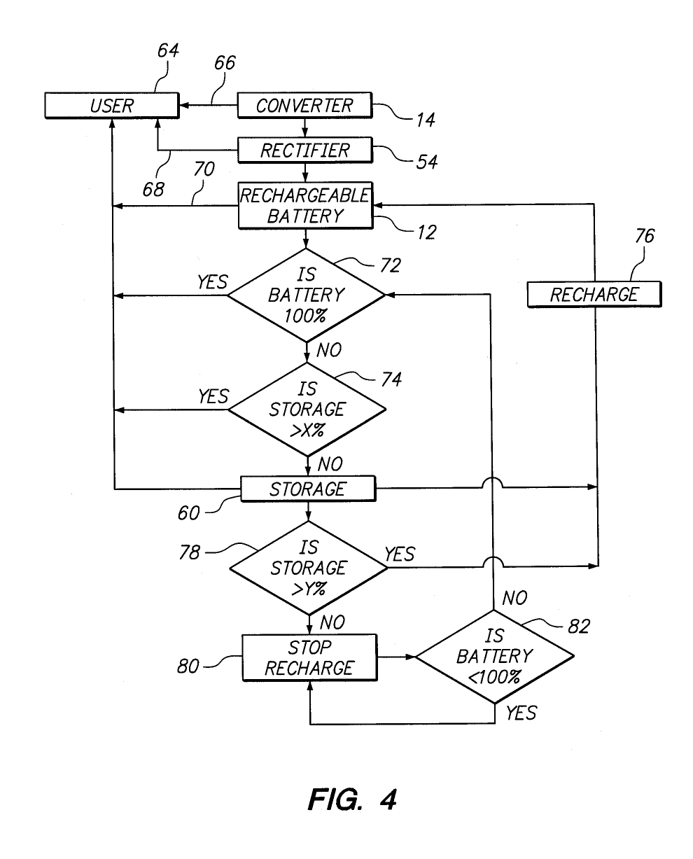

Turning now to FIG. 3, the controlled flow of electrical energy through the system 10 is shown to begin with the operation of an energy conversion unit 18. By way of example, the alternating current (a.c.) electrical energy that is generated in the conductor coil 34 of energy conversion unit 18 is depicted as the graph 50. It is to be noted at this point that the a.c. electrical energy from the conversion unit 18 can be taken directly therefrom to do work. This possibility is indicated by the dash arrow 52 in FIG. 3. The a.c. electrical energy, however, can also be sent from the conversion unit 18 to a rectifier 54 where it is effectively converted to direct current (d.c.) electrical energy. This conversion to d.c. electrical energy is depicted, by example, in graph 56. If desired, the d.c. electrical energy can be taken directly from rectifier 54 and used to do work. This possibility is indicated by the dash arrow 58. Alternatively, the d.c. electrical energy can be transferred either to the re-chargeable battery 12, or diverted to a storage unit 60. From the storage unit 60, d.c. electrical energy (see graph 62) can be subsequently used to automatically recharge the re-chargeable battery 12. With the above structural and functional aspects of the system 10 in mind, an operational overview as to how the system 10 works under control of the central controller 16 will be best understood with reference to FIG. 4.

In FIG. 4 it is to be appreciated that the converter 14, the rectifier 54, and the re-chargeable battery 12 all function substantially as disclosed above. Further, FIG. 4 shows that electrical energy from the converter 14 is available to a user 64 from each of these components. Specifically, as indicated by the line 66 in FIG. 4, a.c. electrical energy is available to the user 64 directly from the converter 14 (i.e. energy conversion unit 18). Line 68 in FIG. 4 indicates that d.c. electrical energy is also available to the user 64 from the rectifier 54. Further, line 70 indicates that electrical energy is available from the battery 12. These are all direct access sources (i.e. converter 14, rectifier 54 and battery 12) of electrical energy, and they provide this energy to user 64 either selectively or simultaneously. Importantly, however, the system 10 provides for automatically replenishing the supply of electrical energy. As mentioned above, this capability of system 10 comes from its ability to harness energy from the various external random forces to which the system 10 may be operationally subjected.

For the process of automatically replenishing, or renewing, the available electrical energy in system 10, FIG. 4 indicates that the central controller 16 continuously monitors the charge state of the re-chargeable battery 12 (see inquiry block 72). If the battery 12 is not 100% charged, central controller 16 then determines the availability of electrical energy from the storage unit 60. For purposes of making this determination, the availability of electrical energy is expressed as a percentage of the full storage capacity of storage unit 60 (e.g. 75% means the storage unit 60 is 75% full). For purposes of the present invention, the storage unit 60 is preferably a capacitor. This, however, is only exemplary. As envisioned for the system 10, the storage unit 60 may actually be another battery (not shown). In any event, inquiry block 74 indicates that the central controller 16 will divert electrical energy to the storage unit 60 for storage, when the additional storage capability falls below a predetermined level (e.g. <x %). In this case, a typical level is reached when the storage unit 60 is less than about 95% full. Action block 76 then shows that electrical energy stored in the storage unit 60 is available for recharging the re-chargeable battery 12. More specifically, this availability continues so long as the amount of electrical energy in storage unit 60 remains above another predetermined level (e.g. >y %).

As indicated in FIG. 4, inquiry block 78 will allow recharging of the re-chargeable battery 12 from the storage unit 60 until the capability of the storage unit 60 falls below a predetermined level (y %). Typically this will be about 10% of its full capacity. When the storage unit 60 is less than this level (i.e. 10%), action block 80 shows that central controller 16 will stop recharging operations. And, inquiry block 82 indicates that once this happens, recharging operations will cease until the storage unit 60 is again at 100% capacity.

While the particular Auto-Charging Battery System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for automatically recharging a battery which comprises:
a device for converting kinetic energy into electrical energy;
a storage unit; and
a central controller for receiving the electrical energy from the device and selectively diverting a first portion of the electrical energy to the storage unit for storage, and selectively transferring a second portion of the electrical energy to the battery for recharging the battery.

2. A system as recited in claim 1 wherein the storage unit is a capacitor.

3. A system as recited in claim 1 wherein the device comprises:
a support unit;
a permanent magnet mounted on the support unit for reciprocal movement along a defined pathway; and
a coiled conductor surrounding the pathway, with the conductor oriented substantially perpendicular to the pathway for generating electrical energy in the conductor in response to movements of the permanent magnet along the pathway.

4. A system as recited in claim 3 further comprising:
a plurality of permanent magnets mounted on the support unit for reciprocal movement along a respective pathway; and
a plurality of coiled conductors with each coiled conductor surrounding a respective pathway for collectively generating the electrical energy.

5. A system as recited in claim 3 further comprising a rectifier for converting an a.c. current generated by kinetic energy movements of the permanent magnet into a d.c. current for recharging the battery.

6. A system as recited in claim 5 wherein the rectifier is a plurality of one-way diodes.

7. A system for automatically recharging a battery which comprises:
a mechanical device for converting kinetic energy into electrical energy;
an electrical connection for selectively transferring the electrical energy from the device to the battery for recharging the battery;
a storage unit for selectively receiving and storing at least a portion of the electrical energy;
a means for monitoring the storage unit to identify the amount of electrical energy stored in the storage unit, wherein the amount of stored electrical energy is characterized as a percentage of the full capacity of the storage unit; and
a central control means for diverting electrical energy from the device to the storage unit for storing the electrical energy when the percentage of full capacity of the storage unit is below a first value, for stopping a recharge of the battery when the percentage of full capacity of the storage unit is below a second value, and for exclusively diverting electrical energy from the device to the storage unit after the percentage of full capacity falls below the second value, and for continuing exclusive diversion thereafter until the percentage of full capacity of the storage unit is one hundred percent.

8. A system as recited in claim 7 wherein the electrical energy has an a.c. current and the system further comprises a means for rectifying the a.c. current to a d.c. current for use in recharging the battery.

9. A system as recited in claim 7 wherein the storage unit is a capacitor.

10. A system as recited in claim 7 wherein the first value is approximately ninety five percent and the second value is approximately ten percent.

11. A system as recited in claim 7 wherein the device comprises:
a support unit;
a permanent magnet mounted on the support unit for reciprocal movement along a defined pathway; and
a coiled conductor surrounding the pathway, with the conductor oriented substantially perpendicular to the pathway for generating electrical energy in the conductor in response to movements of the permanent magnet along the pathway.

12. A system as recited in claim 11 further comprising:
a plurality of permanent magnets mounted on the support unit for reciprocal movement along a respective pathway; and
a plurality of coiled conductors with each coiled conductor surrounding a respective pathway for collectively generating the electrical energy.

13. A method for automatically recharging a battery which comprises the steps of:
using a mechanical device for converting kinetic energy into electrical energy;
selectively transferring the electrical energy from the device to the battery for recharging the battery;
providing a storage unit for selectively receiving and storing at least a portion of the electrical energy;
monitoring the storage unit to identify the amount of electrical energy stored in the storage unit, wherein the amount of stored electrical energy is characterized as a percentage of the full capacity of the storage unit;
diverting electrical energy from the device to the storage unit for storing the electrical energy when the percentage of full capacity of the storage unit is below a first value;
stopping a recharge of the battery when the percentage of full capacity of the storage unit is below a second value;
exclusively diverting electrical energy from the device to the storage unit, after the stopping step, until the percentage of full capacity of the storage unit is one hundred percent; and
returning to the selectively transferring step after the exclusively diverting step has been completed.

14. A method as recited in claim 13 wherein the electrical energy has an a.c. current and the method further comprises the step of rectifying the a.c. current to a d.c. current for use in recharging the battery.

15. A method as recited in claim 14 wherein the rectifying step is accomplished using a plurality of one-way diodes.

16. A method as recited in claim 13 wherein the storage unit is a capacitor.

17. A method as recited in claim 13 wherein the first value is approximately ninety five percent.

18. A method as recited in claim 13 wherein the second value is approximately ten percent.

19. A method as recited in claim 13 wherein the conversion of kinetic energy into electrical energy is accomplished by the steps of:
providing a support unit;
mounting a permanent magnet on the support unit for reciprocal movement along a defined pathway; and
surrounding the pathway with a coiled conductor, wherein the conductor is oriented substantially perpendicular to the pathway for generating electrical energy in the conductor in response to movements of the permanent magnet along the pathway.

20. A method as recited in claim 19 wherein the mounting step involves a plurality of permanent magnets mounted on the support unit for reciprocal movement along a respective pathway and the surrounding step involves a plurality of coiled conductors, with each coiled conductor surrounding a respective pathway for collectively generating the electrical energy.
